(19) United States
(12) Patent Application Publication
(10) Pub. No.: US 2023/0134035 A1
(43) Pub. Date: May 4, 2023

(54) SYSTEMS AND METHODS FOR PRIORITIZING REPAIR AND MAINTENANCE TASKS IN TELECOMMUNICATIONS NETWORKS

(71) Applicant: Level 3 Communications, LLC., Broomfield, CO (US)

(72) Inventors: Thomas C. WOLDAHL, Phoenix, AZ (US); Leigh A. BENSON, Nerderland, CO (US); Peter J. GEORGE, Westminster, CO (US); Leila F. AFZALI, Denver, CO (US)

(21) Appl. No.: 17/974,006

(22) Filed: Oct. 26, 2022

Related U.S. Application Data
(60) Provisional application No. 63/274,400, filed on Nov. 1, 2021.

(51) Int. Cl. G06Q 10/06; H04L 41/0631

(52) U.S. Cl. CPC G06Q 10/06375; H04L 41/064

(57) ABSTRACT

Aspects of the present disclosure include systems and methods for identifying, quantifying, and prioritizing repair, maintenance and system change opportunities within a telecommunications network. This disclosure describes doing so by obtaining churn, repair, and outage data and processing the obtained data using various models and algorithms to provide meaningful insights into the business impact of undertaking some action, which may include proactive maintenance, repair, and/or some form of system change (e.g., upgrade). In the cases of maintenance and repair, the system may further identify a particular issue and the resolution. The system may also provide information as to costs and return for various actions, which may assist the operator in taking actions that will provide optimal customer satisfaction.

### CROSS-REFERENCE TO RELATED APPLICATION

This application is related to and claims priority under 35 U.S.C. § 119(e) from U.S. Patent Application No. 63/274,400 filed Nov. 1, 2022 entitled “SYSTEMS AND METHODS FOR PRIORITIZING REPAIR AND MAINTENANCE TASKS IN TELECOMMUNICATIONS NETWORKS,” the entire contents of which is incorporated herein by reference for all purposes.

### TECHNICAL FIELD

The present disclosure relates to systems, methods, and storage media for analyzing the service impact of issues within a telecommunications network and for automatically and dynamically prioritizing corresponding repair, maintenance, and upgrade tasks.

### BACKGROUND

Telecommunication network operators look to provide their customers with consistent, reliable, and high-quality services. By doing so, the operator can correspondingly maintain customer satisfaction and lower churn, i.e., the number or rate of customers leaving the operator for competitors.

While repairing and maintaining a telecommunications network is critical to meeting customer expectations, telecommunications network operators conventionally rely on a customer to contact the operator when he or she experiences a problem. The operator, in many instances, then sends a technician to diagnose and correct the problem. The typical paradigm is thus responsive, and proactive trouble shooting and maintenance is often ad hoc. Moreover, when available, operators cannot always identify which proactive repair- and maintenance-related tasks should be prioritized. Among other things, a network operator may not be able to accurately prioritize tasks because the network operator cannot quantify or characterize the current or potential impact of a network issue. Stated differently, there is a need for a tool or system that provides an efficient way to identify and prioritize repair and maintenance opportunities and that provides meaningful insight into the potential business impact of such opportunities.

It is with these observations in mind, among others, that the inventors conceived of aspects of the present disclosure.

### SUMMARY

One aspect of the present disclosure relates to a computer-implemented method for analyzing telecommunications networks. The method may include the operations of accessing time series service data for a cross box of a telecommunications network, wherein the time series service data includes information representative of customer churn, repair associated with the cross box, and outages associated with the cross box, identifying, using a processor, a structural shift in the time series service data by identifying a repeating trend in the time series service data and a deviation from the repeating trend, and presenting an element associated with a business impact of the structural shift in a user interface of a computing device, wherein a characteristic of the element corresponds to a degree of the business impact. Other aspects of the present disclosure relate to a computer system comprising one or more data processors and a non-transitory computer-readable storage medium containing instructions which, when executed by the one or more data processors, cause the one or more data processors to perform the above operations. Still another aspect of the present disclosure relates to computer-program product tangibly embodied in a non-transitory machine-readable storage medium, including instructions configured to cause a computing device to perform the above operations.

Another aspect of the present disclosure relates to a computer-implemented method for analyzing telecommunications networks. The method of include the operations of obtaining time series service data for a cross box of a telecommunications network, wherein the time series service data is based on service data including each of customer churn data, repair data, and outage data for the cross box and generating a predicted business impact for a defect of the cross box by providing a feature vector based on the time series service data to a forecasting model for the cross box, wherein the forecasting model is configured to receive the feature vector and to output the predicted business impact. Other aspects of the present disclosure relate to a computer system comprising one or more data processors and a non-transitory computer-readable storage medium containing instructions which, when executed by the one or more data processors, cause the one or more data processors to perform the above operations. Still another aspect of the present disclosure relates to computer-program product tangibly embodied in a non-transitory machine-readable storage medium, including instructions configured to cause a computing device to perform the above operations.

Still another aspect of the present disclosure relates to a computer-implemented method for estimating customer churn for telecommunications networks. The method may include the operations of obtaining customer characteristic data for a customer receiving telecommunications service through a cross box of a telecommunications network, obtaining diagnostic data for the cross box, and generating a churn risk by providing a feature vector based on each of the customer characteristic data and the diagnostic data to a churn risk model, wherein the churn risk model is configured to receive the feature vector and to output the churn risk and wherein the churn risk corresponds to a risk that a customer will cancel a telecommunications service of the customer. Other aspects of the present disclosure relate to a computer system comprising one or more data processors and a non-transitory computer-readable storage medium containing instructions which, when executed by the one or more data processors, cause the one or more data processors to perform the above operations. Still another aspect of the present disclosure relates to computer-program product tangibly embodied in a non-transitory machine-readable storage medium, including instructions configured to cause a computing device to perform the above operations.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. It should be noted that the drawings are not necessarily to scale; however the emphasis instead is being placed on illustrating the principles of the inventive concepts. Also, in the drawings the like reference characters may refer to the same parts or similar throughout the different views. It is intended that the embodiments and figures disclosed herein are to be considered illustrative rather than limiting.

FIG. 1 is a schematic diagram illustrating an exemplary network environment operable to identify, quantify, and prioritize repair, maintenance and system change opportunities within a telecommunications network, according to aspects of the present disclosure.

FIG. 2 is a block diagram illustrating a service monitoring system obtaining and analyzing various data, according to aspects of the present disclosure.

FIG. 3 is a block diagram illustrating details of the operation of the service monitoring system including general data flow and processing by the service monitoring system of various data, according to aspects of the present disclosure.

FIG. 4A is a graph illustrating a first customer index line obtained from the service monitoring system, according to aspects of the present disclosure.

FIG. 4B is a graph illustrating a second customer index line obtained from the service monitoring system, according to aspects of the present disclosure.

FIG. 5 is a first visual representation of data presented by network analysis platform in a user interface, according to aspects of the present disclosure.

FIG. 6 is a second visual representation of data presented by network analysis platform in a user interface, according to aspects of the present disclosure.

FIG. 7 is a diagram illustrating operation of a forecaster component of the service monitoring system, including training and updating of models of forecaster, according to aspects of the present disclosure.

FIG. 8 is a graph illustrating an example output related to a repair forecast for a cross box, according to aspects of the present disclosure.

FIG. 9 is a flow chart illustrating a method for analyzing telecommunication networks and, in particular, a cross box of a telecommunications network, according to aspects of the present disclosure.

FIG. 10 is a flow chart illustrating a method of predicting business impacts of repair and maintenance tasks for cross boxes within a network, according to aspects of the present disclosure.

FIG. 11 is a diagram illustrating operation of churn risk estimator, including training and updating of churn risk estimator, according to aspects of the present disclosure.

FIG. 12 is a block diagram illustrating an example of a computing device or computer system which may be used in implementations of the present disclosure.

### DETAILED DESCRIPTION

The present disclosure describes systems and methods for use in operating telecommunications networks. Aspects of the present disclosure include systems and methods for identifying, quantifying, and prioritizing repair, maintenance and system change opportunities within a telecommunications network. This disclosure describes doing so by obtaining churn, repair, and outage data and processing the obtained data using various models and algorithms to provide meaningful insights into the business impact of undertaking some action, which may include proactive maintenance, repair, and/or some form of system change (e.g., upgrade). In the cases of maintenance and repair, the system may further identify a particular issue and the resolution. The system may also provide information as to costs and return for various actions, which may assist the operator in taking actions that will provide optimal customer satisfaction.

The systems and methods of this disclosure may process and analyze data at a cross box level. In one example, the system accesses available data from discrete cross boxes of a telecommunications network. A cross box, which also has various other designations in the industry, is a device in a network that includes a connection for accessing the network, such a connection to a central office, and many connections to discrete service points (e.g., a modem or other device at a customer). The cross box may be a device in a local loop of the network. Among other things, analyzing data for a given cross box may include evaluating the current profitability or related metrics of the cross box. For example, systems according to the present disclosure may determine whether revenue for customers served by the cross box outweigh the costs of repairing and maintaining the cross box and the access network associated with the cross box. Systems according to the present disclosure may also identify changes in the obtained data to find inflection points (e.g., substantial or structural changes in customer or repair/maintenance trends) or crossover points (e.g., changes in customer or repair/maintenance trends resulting in a cross box becoming unprofitable) to facilitate prioritization of repair and maintenance tasks.

In addition to evaluating current data for cross boxes, aspects of the present disclosure also include projecting impacts of repair and maintenance activities for a cross box. For example, in certain implementations, systems of the present disclosure may include an automated forecaster for a cross box. The system can then be used by either a forecaster or other strategic planner to determine the potential impact of undertaking or foregoing a given repair or maintenance task. The model is automatically updated and refined based on new incoming data and/or later comparison between the predictions made by the model and actual outcomes from undertaking or foregoing the task.

The systems and methods of the present disclosure may support a wide range of departments and operations of a network operator. For example, a repair and maintenance department may use the identification and prioritization of repair and maintenance tasks provided by the systems and methods to create job tickets, to plan work schedules and routes, and to plan and schedule orders for equipment and tools. As another example, a business strategy-related organization of a network operator may use the data provided by the systems and methods of this disclosure to make strategic decisions regarding investment and expansion of a network and services provided by the network. As yet another example, a marketing organization of a network operator may rely on the system to identify potential hot spots of customer churn or new customer opportunities for purposes of directing marketing and promotion efforts. Considering the foregoing, each such organization may generally have access to information provided by systems of this disclosure, such as through a web portal, an application, or other type of user interface that may be used to access and further analyze information, generate reports and summaries, and the like. The system may also automatically generate and transmit reports and summaries (e.g., by email) including information and summaries relevant to organizations and departments of the network operator.

While this disclosure primarily discusses applications related to repair and maintenance activities, aspects of this disclosure may be readily adapted to assess the benefits for performing upgrades to network equipment. For example, like determining the business impact of repair and maintenance tasks, systems and methods according to this disclosure may predict the business impact of upgrading components of a cross box, particularly upgrades that may improve performance, reliability, or capacity of the cross box.

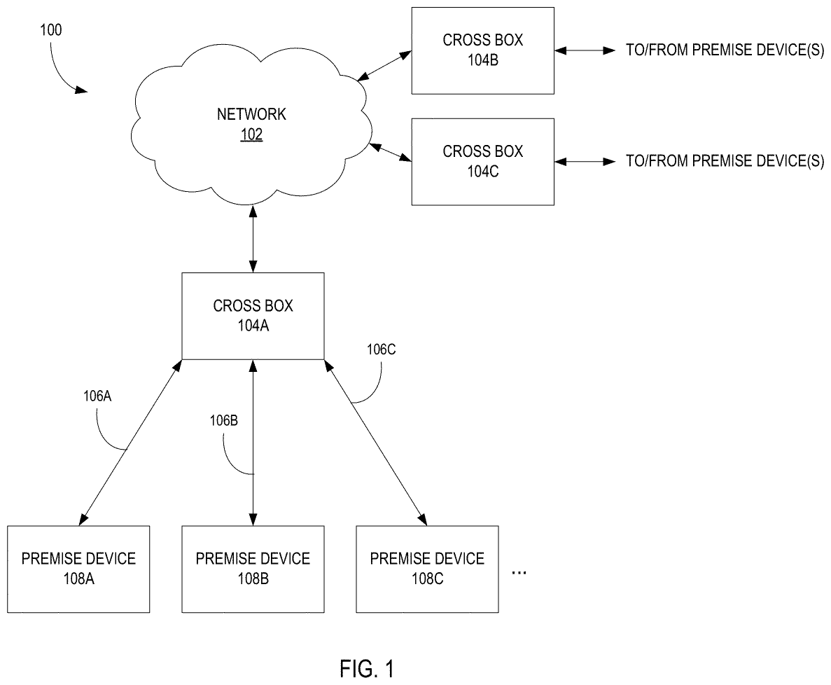

FIG. 1 illustrates a network environment 100 to provide context for aspects of the present disclosure. The network environment 100 includes a network 102, such as a metro and/or backbone network that supplies telecommunications services to various end user. For purposes of the present disclosure, the term “customer” refers to consumers of telecommunications services regardless of the relationship or terms of the relationship between the consumer and provider of the telecommunications services. This disclosure uses the term “customer” for convenience and clarity only and the term “customer” does not limit any aspect of the present disclosure and its applications. Moreover, the disclosure uses network environment 100 of FIG. 1 as an example to lend context to the following discussion, but aspects of this disclosure may be applicable to telecommunications networks having other configurations. Accordingly, the network environment 100 should be considered as one example environment within which aspects of the present disclosure may be implemented and should not be viewed as limiting.

As illustrated, network 102 communicates with multiple cross boxes, such as cross box 104A, cross box 104B and cross box 104C. The following discussion focuses on cross box 104A; however, aspects of cross box 104A apply generally to cross box 1048 and cross box 104C unless otherwise stated. Cross box 104A is an example of a bridge device that facilitates communication between premise devices and broader networks. As illustrated, cross box 104A facilitates communication between each of premise device 108A, premise device 108B, and premise device 108C and network 102 via respective local loops (i.e., local loop 106A, local loop 106B, and local loop 106C). for convenience, the portion of network environment 100 between and including cross box 104A and each of premise device 108A, premise device 108B, and premise device 108C may be referred to herein as an access network.

While the network environment 100 of FIG. 1 illustrates only three cross boxes 104A-104C, any suitable number of cross boxes may be in communication with the network 102. Similarly, each cross box may connect to any number of local loops, each of which may connect to a respective premise device. For example, cross boxes 104B and 104C may each communicate with one or more respective local loops; however, for clarity, FIG. 1 omits these local loops. This disclosure further appreciates that terminology within the telecommunications industry may vary for certain pieces of equipment, including different terminology used to denote similar or the same equipment for supplying different functionality based on context. To the extent this disclosure refers to cross boxes, any such references should be more universally understood to refer to any equipment providing a termination point for local loops and that facilitates connection to a broader network. For example and without limitation, cross boxes within this disclosure may generally be substituted with any of access point, cabinets (cabs), breakout boxes (B-boxes, cross-connect boxed, jumper wire interfaces, outside plant interfaces, pedestals (peds), primary cross-connection points, secondary cross-connections points, telecom cabinets, or serving area interfaces. Notably, such devices may provide additional functionality beyond that noted above. For example, a digital subscriber line access multiplexer (DSLAM) may be used in place of a cross box to provide a termination point for local loops and to facilitate communication with a broader high-speed network, but may also provide multiplexing functionality required for communication over the high-speed network.

A given cross box may serve a broad number and range of customers. For example, in rural settings, a single cross box may only serve a dozen or fewer customers. In contrast, in urban settings, such as when a cross box serves a high rise or high-density residential neighborhood, a cross box may serve several thousand customers.

Many issues impacting services to customers occur at the local level, e.g., within the access network associated with a particular cross box, and a substantial quantity and proportion of maintenance and repair tasks involve cross boxes, local loops, and premise equipment. Often, the complete scope of repairs to make, maintenance tasks to perform, upgrades to install, etc. outstrip the resources available to a network operator and the network operator must decide how to prioritize associated tasks. In general, network operators prefer to prioritize tasks with the highest return on investment, which may consider many factors. For example, the return on investment for a certain repair or maintenance task associated with a cross box may take into account whether the task enables new customers to be added to the cross box, enables new or improved services to be provided to existing customers using the cross box, reduces churn of existing customers served by the cross box (e.g., due to more consistent service quality), reduces the number of service calls required for the cross box, or reduces outages and/or outage duration for the cross box. While network operators may appreciate the considerations in prioritizing repair and maintenance tasks, performing such an analysis accurately, efficiently, and for a broad network that may include thousands of cross boxes and hundreds of thousands or even millions of customers is not feasible using conventional techniques and tools.

This disclosure describes systems and methods for overcoming the foregoing issues associated with quantifying and prioritizing repair and maintenance tasks. The systems and methods obtain and process customer, repair, outage, and other data on a cross box-by-cross box basis to find and quantify repair and maintenance opportunities within a telecommunications network. In certain implementations, the systems evaluate the current impact of issues and defects for an access network corresponding to a cross box. In other implementations, the system forecasts potential impact of undertaking and/or foregoing repair and maintenance tasks. So, a network operator may use systems according to the present disclosure to better inform repair and maintenance operations, strategic network expansions and improvements, customer-building initiatives, and other aspects of the network operator's business.

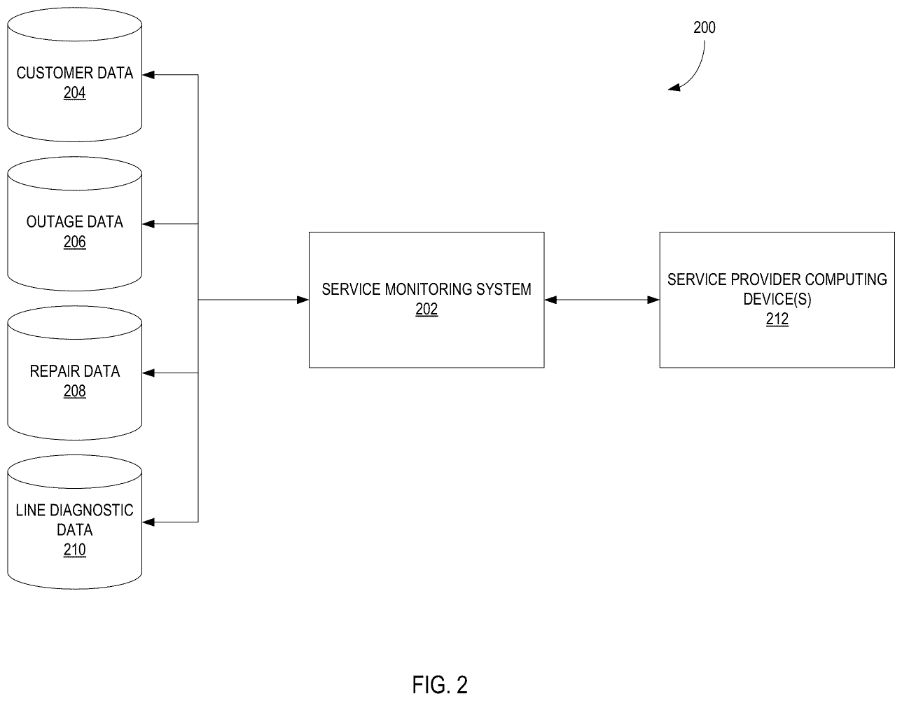

FIG. 2 is a block diagram 200 illustrating an example implementation of the present disclosure. As shown, block diagram 200 includes a service monitoring system 202 that obtains and analyzes various data, such as customer data 204, outage data 206, repair data 208, and line diagnostic data 210. While illustrated as individual data sources in FIG. 2, one or more of customer data 204, outage data 206, repair data 208, and line diagnostic data 210 may be stored in the same data source and/or may be distributed across multiple data sources, provided they are accessible to service monitoring system 202 (e.g., through a suitable API or similar interface). In at least certain implementations, one of more of customer data 204, outage data 206, repair data 208, and line diagnostic data 210 may be stored in a data lake or similar repository accessible by service monitoring system 202.

In general, service monitoring system 202 obtains data from the various data sources included in block diagram 200 and processes the obtained data to supply analysis and recommendations relating to repair and maintenance tasks. Service monitoring system 202 may later present or otherwise make available its results to a user associated with a network operator, such as by using a service provider computing device 212. For example, a network operator may use service provider computing device 212 to access an application or portal that accesses, presents, and allows exploration of the results generated by service monitoring system 202. In other implementations, service monitoring system 202 may generate reports, emails, alerts, or similar communications based on its analysis and the network operator receive or otherwise access such communications using service provider computing device 212. The service monitoring system may operate on a server or servers, or other computing devices accessible by way of a network.

Customer data 204 may include any relevant information about customers of a network service provider. For example, customer data 204 may store demographic data and contact information for customers. Customer data 204 may also store information about historic activity of customers with the network service provider. For a given customer, such information may include, by way of example and without limitation, how long a customer has been receiving service (or when a customer first received service from the network service provide), the customer's current service, and the customer's previous service(s), if any). Customer data 204 may also include historical information regarding interactions between a customer and the network service provider, such as, but not limited to, a history of complaints made by the customer and/or a history of equipment replacements for the customer. Notably, customer data 204 includes both existing and former customers. In the case of a former customer, customer data 204 may include when a customer cancelled his or her service and, if available, a reason for the cancellation. For example, a former customer may indicate that he or she cancelled a service because of a move, dissatisfaction regarding service quality, a better price or service from a competitor, etc. Customer data 204 may also include specific details regarding a customer and provision of network services, such as the cross box to which the customer is connected, and premise equipment used by the customer. In the case of information regarding premise equipment, such information may include a make or model of the premise equipment, a software or firmware version for the equipment, or any other similar information regarding the premise equipment and its operation.

Outage data 206 may include information about network outages. Outage data 206 may be stored on a cross box-by-cross box (or access network-by-access network bass) and may include details regarding any outages experienced by a cross box or customers associated with a cross box. For a given outage, outage data 206 may include, without limitation, a start day/time of the outage, an end day/time of the outage, a duration of the outage, a cause of the outage, a remedy of the outage, a severity of the outage, a number of customers affected by the outage, and the like.

Repair data 208 may include information about repair and maintenance tasks undertaken by the network operator. Repair data 208 may be stored on a cross box-by-cross box (or access network-by-access network basis) and may include details regarding any repair and maintenance tasks related to a cross box or customers associated with a cross box. For a given repair or maintenance task, repair data 208 may include a start day/time of the task, an end day/time of the task, a duration of the task, a description of the task, a code or similar shorthand for the task, a maintenance employee name or ID who performed the task, a priority of the task (e.g., critical, high, medium, low), and the like.

Line diagnostic data 210 may include testing and diagnostic results and related information for local loops. Line diagnostic data 210 may be stored on a cross box-by-cross box (or access network-by-access network basis) and may include details regarding any testing or diagnostics performed on equipment of a cross box or local loops associated with the cross box. For example, for a given diagnostic or test, line diagnostic data 210 may include a day/time of the test, a result of the test, any issues identified by the test, recommendations regarding potential repairs/maintenance, and the like.

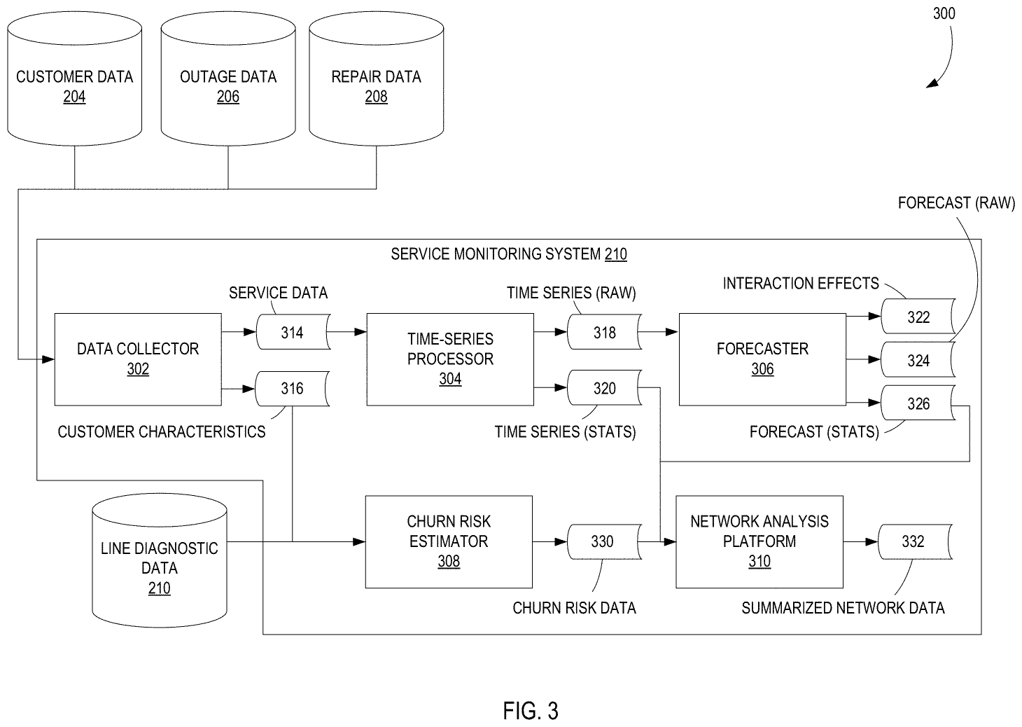

FIG. 3 is a block diagram 300 that further details operation of service monitoring system 202 including general data flow and processing by service monitoring system 202. As illustrated, service monitoring system 202 may include a data collector 302, a time series processor 304, a forecaster 306 and a network analysis platform 310. In general, each of the foregoing may be distinct computing modules incorporated into service monitoring system 202. Alternatively, one or more of the foregoing may be combined into a single computing module, and yet in other instances various operations of the operational units of the system 202 may run on distributed computing elements.

In general, service monitoring system 202 facilitates analysis of access networks on a cross box-by-cross box basis, including determining a current state for a cross box that indicates general profitability of the cross box and predicting the potential impacts of undertaking repair and maintenance associated with the cross box. In certain implementations, service monitoring system 202 may further include a churn risk estimator 308 for use in estimating a churn risk (e.g., a risk that a customer will cancel services) for one or more customers of the network operator.

As shown in FIG. 3, service monitoring system 202 may include data collector 302, which obtains and processes available data into a format suitable for later use by other elements of service monitoring system 202. As shown, data processed by data collector 302 may include customer data 204, outage data 206, and repair data 208, among other data, as discussed above in the context of FIG. 2.

For example, FIGS. 2 and 3 illustrate each of customer data 204, outage data 206, and repair data 208 as separate and monolithic data sources. However, each may be distributed across different data sources with different formats and accessible in different ways. For example, customer data 204 may include general customer information accessible from a customer service database, billing and payment information available from a billing system, and customer complaint data from a service and technical support ticketing system. In such cases, data collector 302 facilitates collection and general preparation of data for use by other elements of service monitoring system 202. For example, data collector 302 may be configured to access various data sources or applications using corresponding interfaces (e.g., APIs), to obtain data required by service monitoring system 202, and then process the data into one or more usable forms. Alternatively, one or more of customer data 204, outage data 206, and repair data 208 may be maintained in a data lake or similar repository of raw/unformatted data. In such cases, data collector 302 may access the data lake to retrieve relevant “blobs” or similar raw data and format the retrieved data. Regardless of the source or format of the data and techniques used to collect it, data collector 302 may generally obtain customer data 204, outage data 206, and repair data 208 and generate each of churn, repair, and outage data, which is collectively referred to as service data 314, and customer characteristics data 316.

Among other things, service data 314 may include churn data and “repair pressure” per cross box. Churn data may include, for example, customer counts indicating the number of customers served by the cross box. Customer counts may change over time as the network operator adds new customers to a cross box and customers associated with the cross box cancel services, with the number of customers cancelling service corresponding to the churn or churn rate for the cross box. In certain implementations service data 314 may include customer counts per day, per week, or per some other frequency may be included in service data 314. As another example, service data 314 may include a customer count for the start of a time period and subsequent changes on a daily, weekly, or other basis. More generally, service data 314 may include any suitable data from which service monitoring system 202 may determine the amount of churn for a given cross box.

This disclosure uses the term “repair pressure” to refer to the repair and maintenance requirements for a cross box. So, for example, a cross box associated with few service calls, low frequency and severity of outages, and capacity for new customers would have low repair pressure. In contrast, a cross box with substantial downtime, many service calls/complaints, and/or that is operating at or near maximum capacity may be considered to have high repair pressure. Stated differently, low repair pressure is associated with low repair, maintenance, and upgrade costs while high repair pressure is associated with high repair, maintenance, and upgrade costs.

Service data 314 may include data related to repair pressure by including related to repair and maintenance tasks for a cross box. Repair and maintenance tasks data for the cross box may include the number of service calls made to the cross box, the number of service complaints received from customers receiving service from the cross box, details or indicators regarding the nature of service call, details and indicators regarding the severity of service calls, and similar information. For example, in certain implementations, service data 314 may include a daily count of service calls or complaints associated with a cross box. Similarly, service data 314 may include data related to outages associated with the cross box. For example, outage data may include the number of outages for the cross box, the start and/or end time of outages, the duration of outages, the severity of outages, the cause of outages, and the like. For example, in certain implementations, service data 314 may include a daily number of outages for a cross box.

As noted above, data collector 302 may also generate customer characteristics data 316. This disclosure describes customer characteristics data 316 and its use below in further detail in the context of churn risk estimator 308. However, by way of introduction, for a given customer, customer characteristics data 316 may include general information (e.g. demographic information) for the customer, information regarding services provided to the customer, equipment used by the customer, and the like. Service monitoring system 202 may use such information to create a model of the customer for later use in assessing a churn risk for the customer.

As illustrated in FIG. 3, service monitoring system 202 may provide service data 314 to time series processor 304. In response to receiving service data 314, time series processor 304 generates one or more corresponding time series based on the service data 314. In certain implementations, time series processor 304 decomposes service data 314 into three distinct time series corresponding to churn, repairs and maintenance, and outages.

In addition to generating time series from service data 314, time series processor 304 may also analyze the generated time series to identify trends and anomalies in the time series. In certain implementations and for each time series, time series processor 304 may initially determine whether the time series includes a repeating trend. For example, the time series for outages or repairs may exhibit seasonality with the number and severity of outages corresponding to times of the year with particularly harsh weather conditions (e.g., winter). As another example, the churn time series may exhibit increased numbers of customers cancelling services during the summer given that families tend to move between school years.

Time series processor 304 may subsequently analyze the generated time series to identify anomalies or structural shifts in the time series taking into account the identified repeated trends. Stated differently, time series processor 304 may analyze the time series to identify notable changes in the time series outside of what is to be expected based on known trends for the time series. For example, time series processor 304 may generally account for increased repairs during harsher months such that a quantity of repairs in the winter may be considered within normal ranges but the same quantity may be identified as anomalous when the same quantity of repairs occur during the summer months. Time series processor 304 may also identify sharp changes in a given time series that may be indicative of significant events, such as storms, major damage to equipment (e.g., due to a vehicle collision), the entrance and aggressive marketing of a competitor, and the like.

As shown in FIG. 3, time series processor 304 may output each of a raw time series service data 318 and a statistical time series service data 320. Time series processor 304 may provide raw time series service data 318 to forecaster 306 for later use in forecasting the effects of undertaking certain repair and maintenance tasks, which is described below in further detail.

Time series processor 304 may provide statistical time series service data 320 to network analysis platform 310. In general, network analysis platform 310 is an application, tool, or similar system for generating and presenting meaningful information from service monitoring system 202 to users of service monitoring system 202. For example, network analysis platform 310 may provide or support a user interface (e.g., at service provider computing device 212) through which users may access and review data generated by service monitoring system 202. Alternatively, network analysis platform 310 may generate reports, emails, alerts, or similar communications based on data generated by service monitoring system 202. For example, network analysis platform 310 may be configured to generate a weekly report indicating high priority and/or high value repair and maintenance tasks within a network or geographical area. To the extent network analysis platform 310 generates data for these purposes, such data may be stored as summarized network data 332.

In certain implementations, service monitoring system 202 (e.g., network analysis platform 310 or time series processor 304) may calculate normalized indices for customers data, repair pressure, or other data for a given cross box. Service monitoring system 202 may then compare such indices to determine a general state of the cross box. For example, in certain implementations, a customer index that generally corresponds to revenue for a cross box may be compared to a repair pressure index that generally corresponds to upkeep for the cross box to determine whether the cross box is profitable.

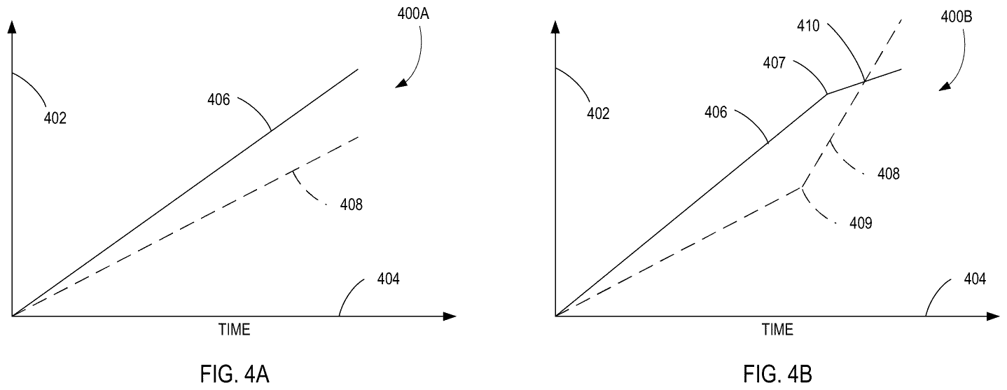

FIGS. 4A and 4B illustrate the concept and use of such indices. FIG. 4A illustrates a graph 400A including an index value axis 402 and a time axis 404. Graph 400A further includes a customer index line 406 and a repair pressure index line 408. Graph 400A illustrates each of a customer base/revenue and corresponding repair pressure increasing over time. In certain implementations, customer index line 406 and repair pressure index line 408 may be cumulative. For example, customer index line 406 may generally correspond to a cumulative number of customers or customer revenue for a cross box while repair pressure index line 408 may generally correspond to a cumulative cost or repairs and maintenance for the cross box. With this in mind, when customer index line 406 is above repair pressure index line 408, the cross box may be considered to be profitable with the magnitude of the gap between customer index line 406 and repair pressure index line 408 indicating a level of profitability for the cross box.

Graph 400A illustrates a typical trend for a cross box. Specifically, customer index line 406 increases over time showing that the network operator is adding new customers to the cross box at a relatively steady rate. Repair pressure index line 408 similarly increases over time, indicating that repair and maintenance costs are increasing over time. In general, such increases in repair pressure are expected as the number of customers supported by the cross box. However, the slope of customer index line 406 preferably exceeds that of repair pressure index line 408 such that the increase in customer base more than makes up for the added maintenance and repair costs associated with adding new customers.

In contrast, FIG. 4B illustrates a graph 400B corresponding to a cross box calling for investigation or intervention. Like graph 400A, graph 400B includes customer index line 406 and repair pressure index line 408. However, in contrast to the profitable state of the cross box illustrated in FIG. 4A, the cross box illustrated in FIG. 4B may be considered to be “upside-down” in the sense that the costs of repairing and maintaining the cross box (as indicated by repair pressure index line 408) exceed revenues (or a similar metric) provided by the cross box (as indicated by customer index line 406).

As shown in FIG. 4B, repair pressure index line 408 includes an inflection point 409 at which the slope of repair pressure index line 408 increased in slope. Inflection point 409 may indicate the onset of a negative condition (e.g., an equipment malfunction) or the occurrence of an event (e.g., a storm) that resulted in an increase in repair and maintenance costs for the cross box. Similarly, customer index line 406 includes an inflection point 407 indicating a decrease in the number of customers of the cross box (or at least a reduction in the rate at which the network operator is adding new customers to the cross box). Graph 400B further includes a crossover point 410 indicating when the cross box became unprofitable.

In certain implementations, service monitoring system 202 (e.g., network analysis platform 310) may be configured to identify inflection and/or crossover points, such as those illustrated in FIG. 4B and to generate an alert, message, or report in response to alert employees of the network operator of potentially problematic conditions. In at least certain implementations, network analysis platform 310 may generate or otherwise make accessible graphs, such as those illustrated in FIGS. 4A and 4B, for users of service monitoring system 202.

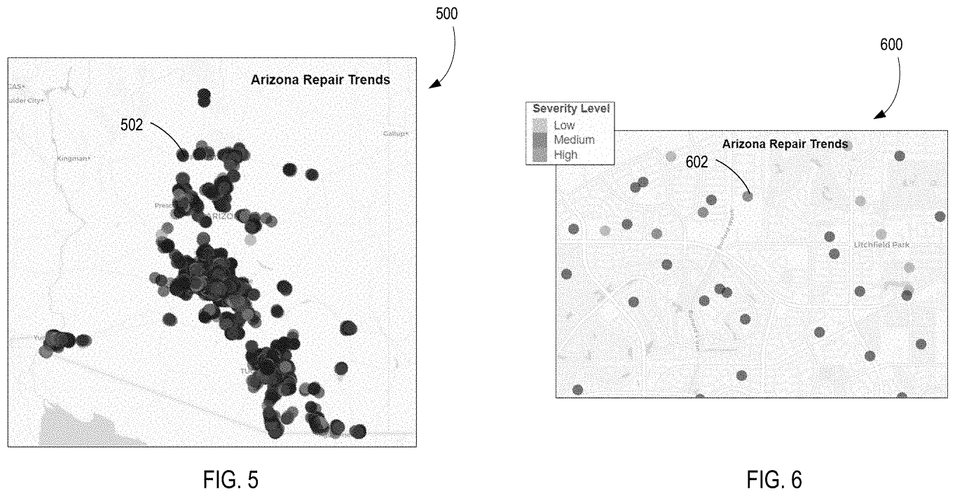

FIGS. 5 and 6 illustrate a visual representation 500 and a visual representation 600, respectively, of data generated by service monitoring system 202 and which may be presented by network analysis platform 310 in a user interface to a user of service provider computing device 212. Visual representation 500 is in the form of a map with visual indicators corresponding to cross boxes overlaid onto the map. Visual representation 600 is a similar map-based representation, albeit on a more local level than visual representation 500. As shown in each of FIGS. 5 and 6, the visual indicators (e.g., visual indicator 502 and visual indicator 602) may be in the form of dots or similar visual elements with one or more characteristics of the visual indicators (e.g., color, shape, opacity, etc.) indicating a relative “severity” for each cross box. In certain implementations, a severity of a cross box may correspond to a general profitability of the cross box. For example, a cross box may be represented by a green dot when the revenues from services provided by the cross box substantially outpace repair and maintenance costs (i.e., the cross box is highly profitable), blue when the revenues from services provided by the cross box moderately outpace repair and maintenance costs (i.e., the cross box is somewhat profitable), and red when the revenues from services substantially are outpaced by repair and maintenance costs (i.e., the cross box is not profitable, is losing money, or is considered “upside-down”).

In certain implementations, the variable characteristic of the visual indicator may be based on a comparison of indices like those illustrated in FIGS. 4A and 4B. For example, the color of the visual indicator may be based on a magnitude of the difference between customer index line 406 and repair pressure index line 408 included in FIGS. 4A and 4B.

The geographic representations of cross box data of FIGS. 5 and 6 can be particularly intuitive for operators to review and analyze. Among other things, geographic representation of cross box data can help to identify broad service-impacting issues (e.g., when multiple red dots are clustered in certain geographic areas) or to help plan routes for repair and maintenance workers. In at least certain implementations, visual representation 500 and visual representation 600 may enable a user to select a dot corresponding to a given cross box to obtain more detailed information regarding the cross box, including detailed customer statistics, repair and maintenance task information, and diagnostic results, among other things.

Referring to FIG. 3, in at least certain implementations, service monitoring system 202 may include forecaster 306. In general, forecaster 306 includes various models and algorithms that may receive raw time series service data 318 from time series processor 304 for a cross box and may generate predictions related to repair and maintenance activities for the cross box. For example, forecaster 306 may predict the potential business impact of installing an upgrade at the cross box, making a repair associated with the cross box, or foregoing such activities altogether. Stated differently, forecaster 306 can be predict and quantify the return for repair and maintenance activities for a cross box.

As illustrated, forecaster 306 may generate raw forecast data 324 as well as statistical forecast data 326, which may be provided to network analysis platform 310 for presentation or communication to a user of service monitoring system 202. Forecaster 306 may further generate interaction effect data 322 for use in statistical analysis and refinement of forecaster 306, among other things.

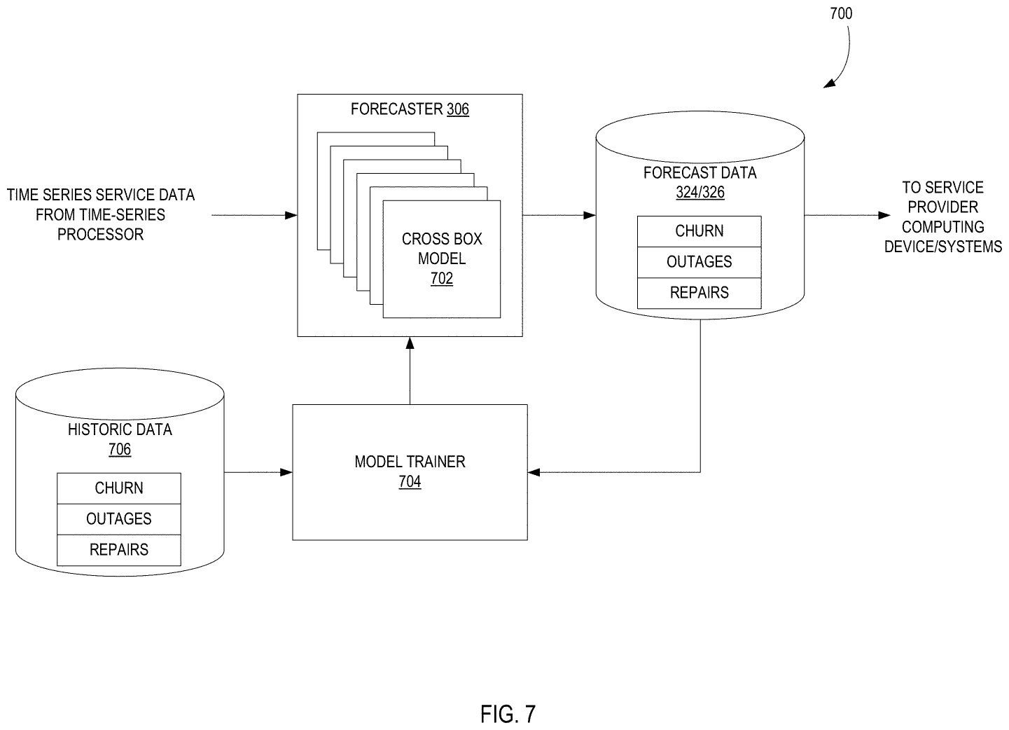

FIG. 7 is a diagram 700 illustrating operation of forecaster 306, including training and updating of models of forecaster 306. As shown in FIG. 7, forecaster 306 may include multiple models, such as model 702. In certain implementations, forecaster 306 includes a model for each cross box within a network operator's network. As a result, forecaster 306 may make specific predictions for each cross box that consider variations in customer base, cross box configuration, access network configuration, and other characteristics, the combination of which may be unique to each cross box within a network.

Diagram 700 includes a model trainer 704 configured to train and update model 702. In certain implementations, service monitoring system 202 may create model 702 for a cross box based on a default model. Alternatively, service monitoring system 202 may create model 702 for the cross box by duplicating an existing model for a different cross box with similar characteristics to the cross box for which service monitoring system 202 is creating model 702. In at least certain implementations, model trainer 704 may also access historic data 706 for the cross box that model trainer 704 may then use to train and refine model 702 after its creation.

During operation, forecaster 306 receives time series data from time series processor 304. For example, forecaster 306 may receive or generate a feature vector including customer, repair, and outage data generated by time series processor 304. In certain implementations, such the data may be time-limited, e.g., limited to the last three months or a similar time period. Forecaster 306 then provides the feature vector as an input to model 702 which outputs one or more forecasts for the cross box related to customer churn, repair and maintenance activities, outages, and the like. Forecaster 306 may then store the forecasts, e.g., as raw forecast data 324 and/or statistical forecast data 326.

In the specific implementation shown in FIG. 7, model 702 produces three forecasts corresponding to customer churn, outages, and repairs. For example, in certain implementations, model 702 may output forecasts for the next twelve months and indicating predicted customer churn; predicted frequency, severity, and duration of outages; and a predicted number of service calls for the cross box.

Forecasts generated by forecaster 306 may be based on whether an operator undertakes certain repairs, updates, maintenance tasks, etc. For example, in addition to the feature vector based on data received from time series processor 304, forecaster 306 may identify certain defects or issues associated with the cross box, e.g., by accessing test results and diagnostic data from line diagnostic data 210 indicating potential defects for the cross box. Forecaster 306 may then generate forecasts based on whether the identified defects are corrected. For example, forecaster 306 may generate a first forecast assuming a defect is unaddressed and a second forecast in which the defect is corrected. Each forecast may then be provided or made available to network analysis platform 310 for presentation to a user.

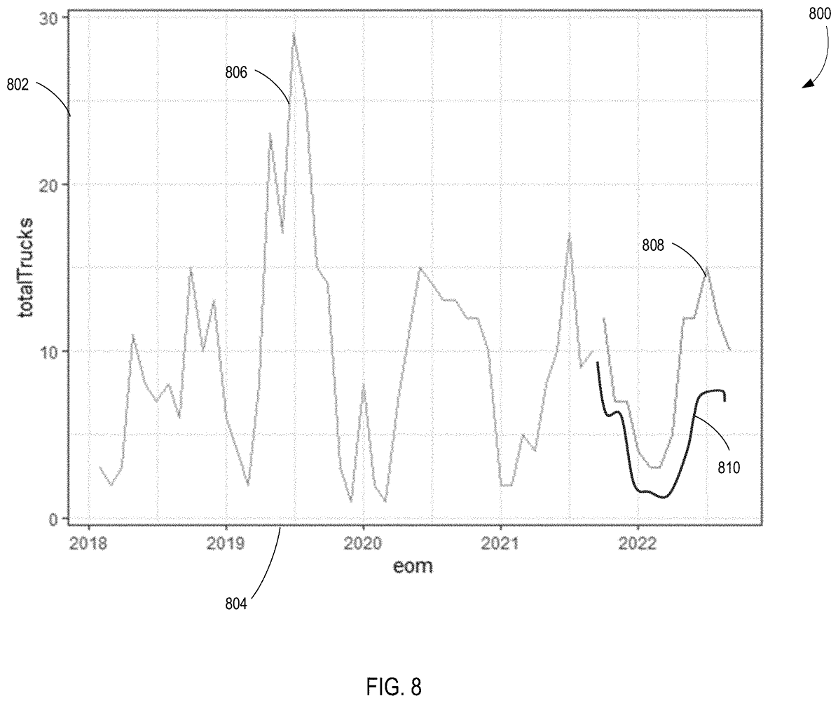

FIG. 8 is a graph 800 illustrates an example output related to a repair forecast for a cross box. Graph 800 or a similar visualization may be provided to or made available to a user, e.g., by network analysis platform 310. As shown, graph 800 includes a first axis 802 indicating the number of service calls for the cross box and a second axis 804 indicating time. Graph 800 includes historic data 806 showing actual service calls conducted for the cross box. Graph 800 further includes a pair of forecasts. A first forecast 808 corresponds to a scenario in which a network operator does not perform a repair or maintenance task while a second forecast 810 indicates the predicted effects of undertaking the repair or maintenance task. As a result, the gap between first forecast 808 and second forecast 810 indicates the relative benefit of undertaking the repair or maintenance task (here, a reduction of two or more service calls per month).

Referring to FIG. 7, model trainer 704 may retrain and refine model 702 and other models of forecaster 306 over time. In at least certain implementations, model trainer 704 may access forecasts provided by model 702 and stored in raw forecast data 324 or statistical forecast data 326 and compare the forecasts to historic data 706 as the dates of the forecasts arrive. Model trainer 704 may then retrain, refine, update, etc. model 702 based on deviations between the forecasts and actual data.

While the foregoing description of forecaster 306 focuses primarily on the effects of repair and maintenance tasks for a cross box, forecaster 306 may also or alternatively assess the impact of upgrading the cross box. For example, in one specific example, service monitoring system 202 or a user of service monitoring system 202 may identify or select one or more upgrades or modifications that may be applied to a cross box. Forecaster 306 may then generate first forecasts based on the existing configuration of the cross box and second forecasts based on a modified or upgraded version of the cross box based on the selected upgrades/modifications. In certain implementations, a comparison of such forecasts may be provided by network analysis platform 310 such that a network operator may readily determine the profitability or return for performing the upgrades.

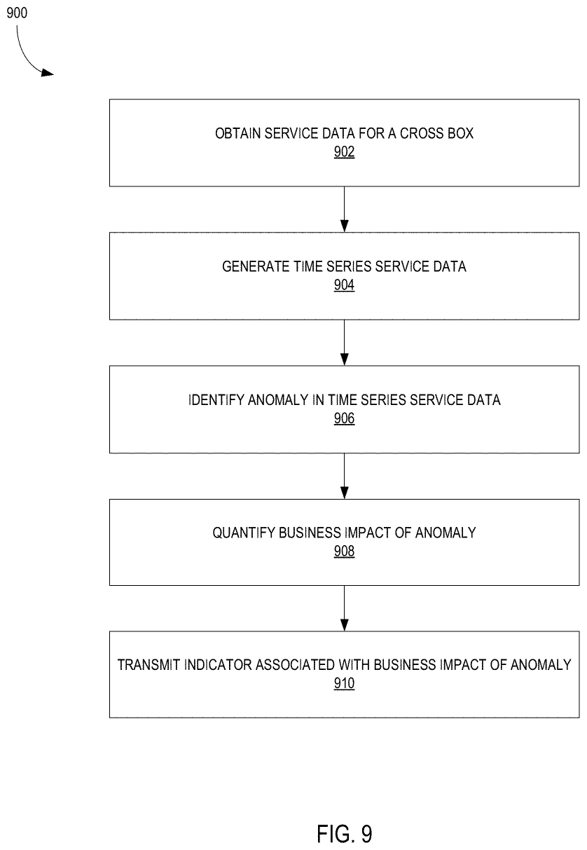

FIG. 9 is a flow chart illustrating a method 900 for analyzing telecommunication networks and, in particular, a cross box of a telecommunications network. In certain implementations, service monitoring system 202 may execute method 900 and reference in the following discussion is made to elements of service monitoring system 202 as discussed in the context of FIG. 3.

At step 902, service monitoring system 202 obtains service data for a cross box. For example, data collector 302 or service monitoring system 202 may access, request, or otherwise obtain service data including churn, repair, and outage data from one or more data sources or applications. In at least certain implementations, data collector 302 may further process any such data into a format suitable for later processing by other elements of service monitoring system 202, e.g., as discussed below in additional steps of method 900.

At step 904, service monitoring system 202 generates one or more time series based on the service data. For example, service monitoring system 202 may include time series processor 304, which receives the service data and generates a time series for each of the churn data, repair, data, and outage data, e.g., by performing a suitable decomposition on the service data.

At step 906, time series processor 304 may also analyze the time series generated in step 904 to identify anomalies or structural shifts in the time series data. In certain implementations, identifying anomalies in the data may include accounting for seasonality or similar repeating trends within the time series data. In one specific example, identifying anomalies within the time series data may include identifying structural shifts, such as Bayesian structural shifts, within the time series data. In at least certain implementations, identifying an anomaly may include identifying a data point that falls outside of a variant span while taking into account repeated trends within the time series data. So, for example, a sharp increase in service calls for a cross box that exceeds the number of service calls expected for that time of year may be considered an anomaly. Another example of an anomaly may be a decline in customers served by the cross box that does not conform to typical cyclical patterns or trends for new customer acquisitions.

At step 908, service monitoring system 202 quantifies a business impact associated with the anomaly. For example and with reference to FIGS. 4A and 4B, service monitoring system 202 may compute each of a customer index and a repair pressure index which generally capture revenues received from customers and repair and maintenance costs, respectively. Accordingly, determining a business impact for a certain anomaly may include identifying a change in the customer index, a change in the repair pressure index, a change in the customer index relative to the repair pressure index, a change in the repair pressure index relative to the customer index, or any combination thereof. For example, with reference to FIG. 4B, service monitoring system 202 may identify an anomaly corresponding to inflection point 409 of repair pressure index line 408 and determine a business impact corresponding to the change in the slope of repair pressure index line 408 (e.g., an increased rate of expenditures for repairing and maintaining the cross box).

At step 910, service monitoring system 202 transmits an indicator associated with the business impact quantified in step 908. When the indicator is received by a computing device, such as service provider computing device 212 of FIG. 2, the indicator causes the computing device to present information associated with the anomaly and the business impact of the anomaly. For example, in certain implementations, the indicator may cause service provider computing device 212 to present a graph like those of FIGS. 4A-4B, a map like those of FIGS. 5 and 6, summary data, or any other data representation via a user interface.

In certain implementations, service monitoring system 202 may transmit an indicator by transmitting an update to a database or similar data store corresponding to the analysis conducted in steps 902-908. In such implementations, receiving the indicator at service provider computing device 212 may include 212 accessing or being provided with the updated data from the data store. In yet another example, transmitting an indicator may include generating a report, email, alert, or similar communication and transmitting the communication to service provider computing device 212 or an account (e.g., an email account) for a user of service provider computing device 212. In such cases, the business impact data may be presented to the user upon opening the communication.

Service monitoring system 202 may more generally present an element corresponding to the business impact through a user interface of a computing device, such as service provider computing device 212. For example, network analysis platform 310 may present the element may following a user accessing network analysis platform 310 using service provider computing device 212. By way of non-limiting example, the element of the user interface corresponding to the business impact may include one or more of an icon, shape, graphic, text, numerical value, graph, table, audio playback, or any other similar element of a user interface that may be used to communicate information to a user. In certain implementations, at least one characteristic of the element may be modified based on the corresponding business impact. Such characteristics may include, without limitation, size, shape, color, visibility, position, orientation, and animation of the element with the intensity or degree of the modification to the element being based on the magnitude of the business impact. Referring to FIGS. 5 and 6, an example element may be a colored dot presented in the user interface with the color of the dot varying based on the degree of business impact.

Method 900 may be executed in response to service monitoring system 202 detecting certain events related to the cross box. For example, in certain implementations, service monitoring system 202 may have access to repair and maintenance data or be in communication with a repair and maintenance system of a network operator. In such cases, service monitoring system 202 may automatically execute method 900 or a similar method for analyzing a cross box in response to various factors that may be tracked by the repair and maintenance system. Among other things, service monitoring system 202 may automatically execute method 900 for a cross box in response to a number of service calls for the cross box exceeding a certain amount or a certain amount over a certain time period. As another example, service monitoring system 202 may execute method 900 or perform a similar analysis on some or all cross boxes within a network on a regular schedule, e.g., weekly such that the data generated and maintained by service monitoring system 202 is kept up to date. As yet another example, service monitoring system 202 may be integrated with a diagnostic system, such as the diagnostic system that produces line diagnostic data 210. In such implementations, service monitoring system 202 may execute method 900 or a similar cross box analysis for a cross box in response to a result of a diagnostic performed on the cross box indicating an issue with the cross box. As a result, service monitoring system 202 may ensure that up-to-date analyses for potentially problematic cross boxes within a network are readily available to users of service monitoring system 202.

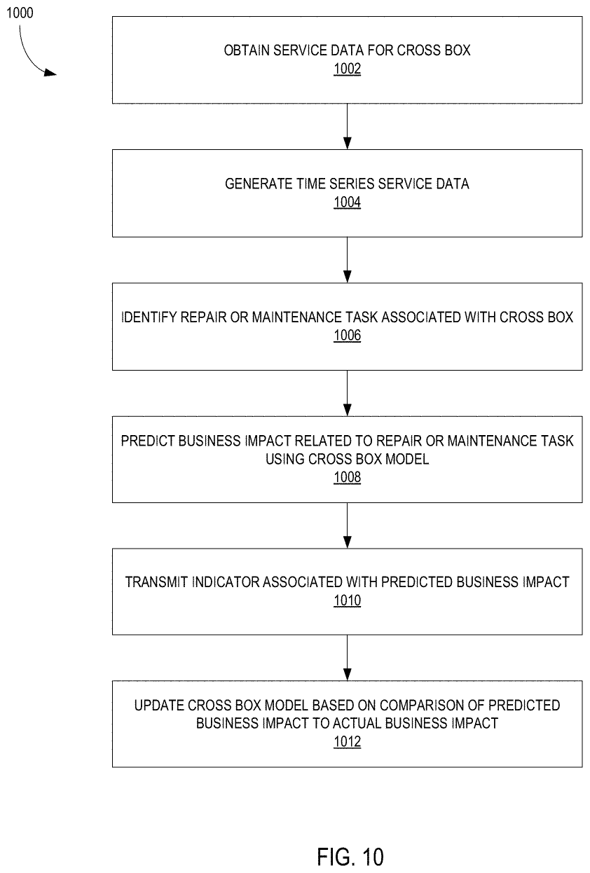

FIG. 10 is a flow chart illustrating a method 1000 of predicting business impacts of repair and maintenance tasks for cross boxes within a network. Like method 900 of FIG. 9, method 1000 may be executed by service monitoring system 202 but is not necessarily limited to being executed by service monitoring system 202. Nevertheless, the following discussion refers to service monitoring system 202 and its various elements for context. Further reference is also made to FIG. 7, which illustrates forecaster 306 in predicting business impacts of repair and maintenance tasks.

At step 1002, service monitoring system 202 obtains service data for a cross box. For example, data collector 302 or service monitoring system 202 may access, request, or otherwise obtain churn, repair, and outage data from corresponding data source or applications. In at least certain implementations, data collector 302 may further process any such data into a format suitable for subsequent processing.

At step 1004, service monitoring system 202 generates one or more time series based on the service data. For example, service monitoring system 202 may include time series processor 304, which receives the service data and generates a time series for each of churn, repairs, and outages, e.g., by performing a suitable decomposition on the service data.

At step 1006, service monitoring system 202 identifies a repair or maintenance task associated with the cross box. For example, in certain implementations, service monitoring system 202 may access line diagnostic data 210 to identify what, if any, defects may have been detected during diagnostic testing of the cross box. Alternatively, service monitoring system 202 may receive a selection of a particular repair or maintenance task for the cross box from a user.

At step 1008, service monitoring system 202 predicts the potential business impact associated with undertaking the repair or maintenance task identified in step 1006. For example, service monitoring system 202 may include forecaster 306 which receives a feature vector including time series data from time series processor 304 and a repair or maintenance task for the cross box and provides the feature vector and task to model 702 corresponding to the cross box. Model 702 then forecasts a business impact (e.g., change in churn rate, change in number/cost of service calls, changes in outage length/severity, etc.) associated with the repair or maintenance task. Forecaster 306 may predict either of the business impact of performing the repair or maintenance task or the business impact of foregoing the repair or maintenance task.

At step 1010, service monitoring system 202 generates and transmits an indicator associated with the predicted business impact for the cross box. Like the indicator described above in step 910 of method 900, the indicator generated and transmitted by service monitoring system 202 may generally cause a computing device (e.g., service provider computing device 212) to present the business impact information in a form appropriate for review and analysis by a user of the computing device when received at the computing device.

At step 1012, service monitoring system 202 updates model 702 to improve and refine model 702 for subsequent forecasts and predictions. For example, service monitoring system 202 may include model trainer 704 which may compare previous predictions and forecasts made by model 702 with actual outcomes of undertaking or foregoing repair or maintenance tasks. Model trainer 704 may then modify model 702 based on deviations identified between the forecasts made by model 702 and the actual outcomes.

Referring to FIG. 3, in another aspect of the present disclosure, service monitoring system 202 may be further configured to determine churn risk for customers of a cross box. As previously discussed in the context of FIG. 2, data collector 302 may collect customer data 204 from various sources for use in assessing and predicting business impacts of various repair and maintenance tasks. Data collector 302 may further generate customer characteristics data 316. Customer characteristics data 316 may generally include information to form a model of a customer with parameters that may correspond to the customer's demographics, preferences of the customer, services provided to the customer, the relationship between the customer and the network operator, equipment used by the customer, and other similar factors that may influence whether a customer may decide to maintain or cancel services. Churn risk estimator 308 may further receive line diagnostic data 210, which may be used by service monitoring system 202 to determine the level and quality of service being provided to the customer. In certain instances, churn risk estimator 308 may include a model or algorithm (e.g., an artificial intelligence or machine learning algorithm) that receives a feature vector including customer characteristics data 316 and line diagnostic data 210 and outputs a metric indicating a risk of churn for the customer, which may be stored as churn risk data 330. Churn risk data 330 may later be presented to a user of service monitoring system 202, e.g., through network analysis platform 310.

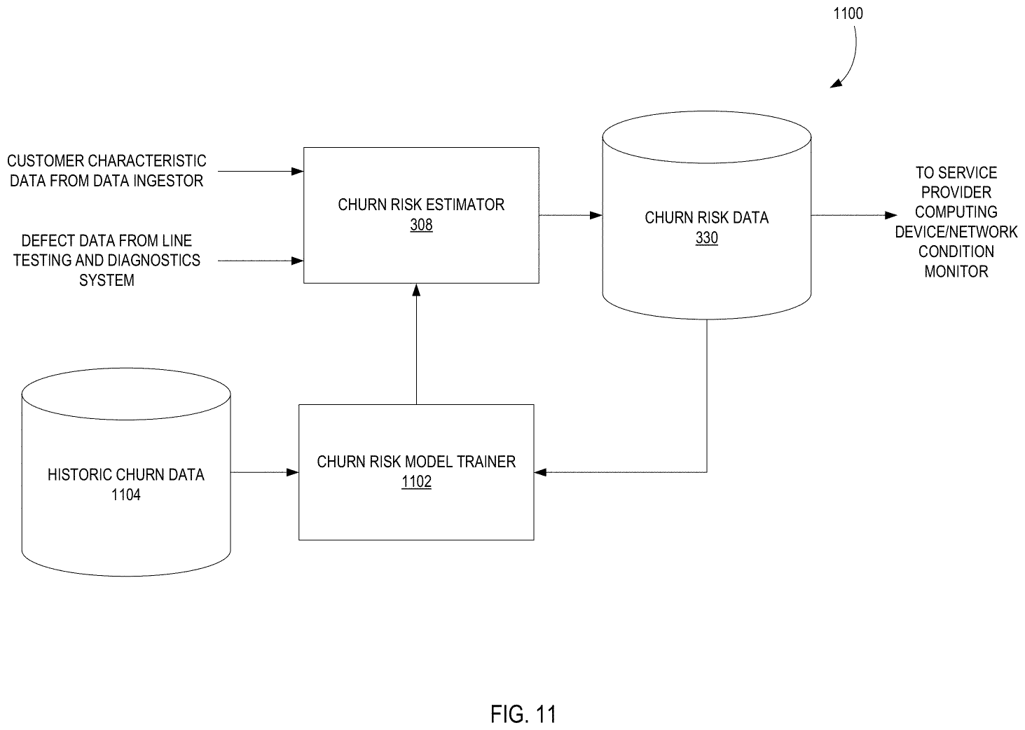

FIG. 11 illustrates churn risk estimator 308 in further detail. FIG. 11 is a diagram 1100 illustrating operation of churn risk estimator 308 including training and updating of churn risk estimator 308. During operation, churn risk estimator 308 receives customer characteristics data 316 for a customer and line diagnostic data 210 for a cross box from which the customer receives services. Based on the received data, churn risk estimator 308 outputs a corresponding risk metric related to churn for the customer. Churn risk estimator 308 may then store the churn prediction, e.g., as churn risk data 330. As shown in FIG. 2, churn risk data 330 may be provided to or otherwise accessible by network analysis platform 310 for later access by a user of service monitoring system 202.

In certain implementations, service monitoring system 202 may include a churn risk model trainer 1102 for updating and refining churn risk estimator 308. For example, in certain implementations, churn risk model trainer 1102 may access churn risk data 330 and compare the predictions stored in churn risk data 330 with historic churn data 1104, which may include actual churn statistics correlated with customer characteristics and/or line diagnostic data. Churn risk model trainer 1102 may then update and refine churn risk estimator 308 based on differences between churn risk data 330 and historic churn data 1104.

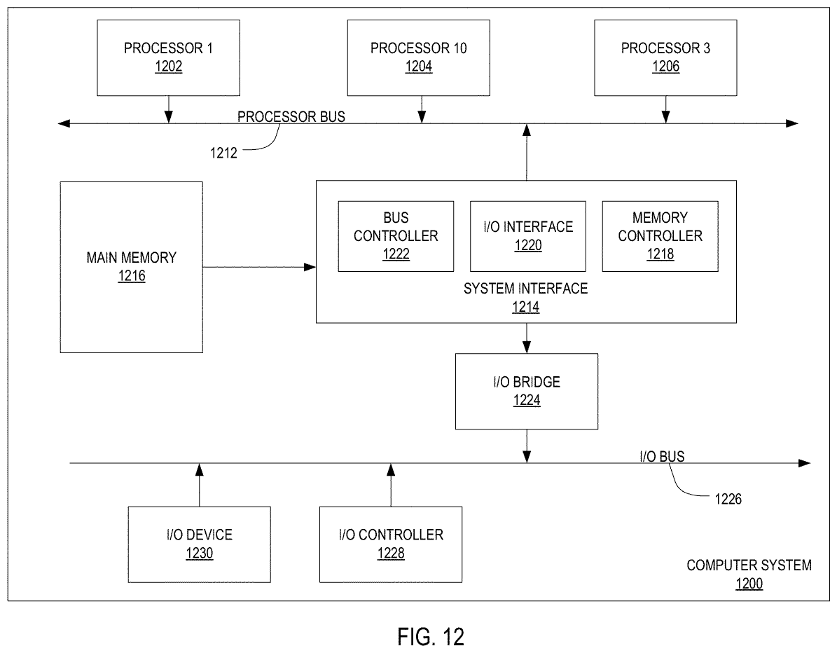

FIG. 12 is a block diagram illustrating an example of a computing device or computer system 1200 which may be used in implementations of the present disclosure. In particular, the computing device of FIG. 12 is one embodiment of any of the devices that perform one of more of the operations described above.

The computer system 1200 includes one or more processors 1202-1206. Processors 1202-1206 may include one or more internal levels of cache (not shown) and a bus controller or bus interface unit to direct interaction with the processor bus 1212. Processor bus 1212, also known as the host bus or the front side bus, may be used to couple the processors 1202-1206 with the system interface 1214. System interface 1214 may be connected to the processor bus 1212 to interface other components of the system 1200 with the processor bus 1212. For example, system interface 1214 may include a memory controller 1218 for interfacing a main memory 1216 with the processor bus 1212. The main memory 1216 typically includes one or more memory cards and a control circuit (not shown). System interface 1214 may also include an input/output (I/O) interface 1220 to interface one or more I/O bridges or I/O devices with the processor bus 1212. One or more I/O controllers and/or I/O devices may be connected with the I/O bus 1226, such as I/O controller 1228 and I/O device 1230, as illustrated.

I/O device 1230 may also include an input device (not shown), such as an alphanumeric input device, including alphanumeric and other keys for communicating information and/or command selections to the processors 1202-1206. Another type of user input device includes cursor control, such as a mouse, a trackball, or cursor direction keys for communicating direction information and command selections to the processors 1202-1206 and for controlling cursor movement on the display device.

System 1200 may include a dynamic, non-transitory storage device, referred to as main memory 1216, or a random access memory (RAM) or other computer-readable devices coupled to the processor bus 1212 for storing information and instructions to be executed by the processors 1202-1206. Main memory 1216 also may be used for tangibly storing temporary variables or other intermediate information during execution of instructions by the processors 1202-1206. System 1200 may include a read only memory (ROM) and/or other static storage device coupled to the processor bus 1212 for storing static information and instructions for the processors 1202-1206. The system set forth in FIG. 9 is but one possible example of a computer system that may employ or be configured in accordance with aspects of the present disclosure.

According to one implementation, the above techniques may be performed by computer system 1200 in response to processor 1204 executing one or more sequences of one or more instructions contained in main memory 1216. These instructions may be read into main memory 1216 from another machine-readable medium, such as a storage device. Execution of the sequences of instructions contained in main memory 1216 may cause processors 1202-1206 to perform the process steps described herein. In alternative embodiments, circuitry may be used in place of or in combination with the software instructions. Thus, embodiments of the present disclosure may include both hardware and software components.

A machine-readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 1216. Common forms of a machine-readable media may include, but is not limited to, magnetic storage media; optical storage media (e.g., CD-ROM); magneto-optical storage media; read only memory (ROM); random access memory (RAM); erasable programmable memory (e.g., EPROM and EEPROM); flash memory; or other types of media suitable for storing electronic instructions.

Embodiments of the present disclosure include various operations, which are described in this specification. The steps may be performed by hardware components or may be embodied in machine-executable instructions, which may be used to cause a general-purpose or special-purpose processor programmed with the instructions to perform the operations. Alternatively, the operations may be performed by a combination of hardware, software, and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A computer-implemented method for analyzing telecommunications networks, the computer-implemented method comprising:
accessing time series service data for a cross box of a telecommunications network, wherein the time series service data includes information representative of customer churn, repair associated with the cross box, and outages associated with the cross box;
identifying, using a processor, a structural shift in the time series service data by identifying a repeating trend in the time series service data and a deviation from the repeating trend; and
presenting an element associated with a business impact of the structural shift in a user interface of a computing device, wherein a characteristic of the element corresponds to a degree of the business impact.

2. The computer-implemented method of claim 1, wherein accessing the time series service data for the cross box is automatic and in response to at least one of:
a total number of service calls occurring for the cross box;
a certain number of service calls for the cross box occurring within a certain time; and
a result of a diagnostic test performed on the cross box.

3. The computer-implemented method of claim 1 further comprising:
computing a customer index corresponding to revenue of a customer base of the cross box; and
computing a repair index corresponding to at least one of repair costs and outage costs for the cross box,
wherein the business impact corresponds to an inflection of one of the customer index and the repair index.

4. The computer-implemented method of claim 1 further comprising:
computing a customer index corresponding to revenue of a customer base of the cross box; and
computing a repair index corresponding to at least one of repair costs and outage costs for the cross box,
wherein the business impact corresponds to a crossover of the customer index and the repair index.

5. The computer-implemented method of claim 1 further comprising:
computing a customer index corresponding to revenue of a customer base of the cross box;
computing a repair index corresponding to at least one of repair costs and outage costs for the cross box; and
computing a relative profitability for the cross box based on the customer index and the repair index.

6. The computer-implemented method of claim 1 further comprising:
obtaining diagnostic data for the cross box;
identifying a defect associated with the cross box from the diagnostic data; and
presenting a recommendation to repair the defect in the user interface of the computing device.

7. A computer system comprising:
one or more data processors; and
a non-transitory computer-readable storage medium containing instructions which, when executed by the one or more data processors, cause the one or more data processors to perform the method of any of claims 1 to 6.

8. A computer-program product tangibly embodied in a non-transitory machine-readable storage medium, including instructions configured to cause a computing device to perform the method of any of claims 1 to 6.

9. A computer-implemented method for analyzing telecommunications networks, the computer-implemented method comprising:
obtaining time series service data for a cross box of a telecommunications network, wherein the time series service data is based on service data including each of customer churn data, repair data, and outage data for the cross box; and
generating a predicted business impact for a defect of the cross box by providing a feature vector based on the time series service data to a forecasting model for the cross box, wherein the forecasting model is configured to receive the feature vector and to output the predicted business impact.

10. The computer-implemented method of claim 9, further comprising transmitting an indicator associated with the predicted business impact, wherein, when the indicator is received by a computing device, the computing device presents an element corresponding to the predicted business impact.

11. The computer-implemented method of claim 9 wherein the predicted business impact is based on repairing the defect.

12. The computer-implemented method of claim 9 wherein the predicted business impact is based on not repairing the defect.

13. The computer-implemented method of claim 9 further comprising initially training the forecasting model using historic business impact data for cross box defects.

14. The computer-implemented method of claim 9 further comprising updating the forecasting model based on a deviation of the predicted business impact associated with the defect and an actual business impact caused by the defect.

15. The computer-implemented method of claim 9, wherein the predicted business impact corresponds to a quantity of service calls for the cross box.

16. The computer-implemented method of claim 9, wherein the predicted business impact corresponds to a change in customer base for the cross box.

17. The computer-implemented method of claim 9, wherein the predicted business impact corresponds to a quantity of service outages for the cross box.

18. A computer system comprising:
one or more data processors; and
a non-transitory computer-readable storage medium containing instructions which, when executed by the one or more data processors, cause the one or more data processors to perform the method of any of claims 9 to 17.

19. A computer-program product tangibly embodied in a non-transitory machine-readable storage medium, including instructions configured to cause a computing device to perform the method of any of claims 9 to 17.

20. A computer-implemented method for estimating customer churn for telecommunications networks, the computer-implemented method comprising:
obtaining customer characteristic data for a customer receiving telecommunications service through a cross box of a telecommunications network;
obtaining diagnostic data for the cross box; and
generating a churn risk by providing a feature vector based on each of the customer characteristic data and the diagnostic data to a churn risk model, wherein the churn risk model is configured to receive the feature vector and to output the churn risk and wherein the churn risk corresponds to a risk that a customer will cancel a telecommunications service of the customer.

21. The computer-implemented method of claim 20, further comprising initially training the churn risk model using historic churn data including historic diagnostic data for cross boxes and historic churn data for the cross boxes.

22. The computer-implemented method of claim 20, further comprising updating the churn risk model based on a deviation of the churn risk generating by the churn risk model and actual churn for the cross box.

23. The computer-implemented method of claim 20, wherein the customer characteristic data includes at least one of:
a service provided to the customer;
a type of customer, wherein the type of customer indicates whether the customer is a residential customer or a business customer;
equipment in use by the customer;
how long services have been provided to the customer;
a customer history, wherein the customer history includes at least one of a complaint history and a modem replacement history of the customer; and
churn data for other customers receiving telecommunications service through the cross box.

24. A computer system comprising:
one or more data processors; and
a non-transitory computer-readable storage medium containing instructions which, when executed by the one or more data processors, cause the one or more data processors to perform the method of any of claims 20 to 23.

25. A computer-program product tangibly embodied in a non-transitory machine-readable storage medium, including instructions configured to cause a computing device to perform the method of any of claims 20 to 23.
